(19) United States
(12) Patent Application Publication
(10) Pub. No.: US 2002/0058595 A1
(43) Pub. Date: May 16, 2002

(54) Process and a device for deodorizing and/or fragrancing an environment

(75) Inventor: Carl-Eric Kaiser, Mason, OH (US)

Correspondence Address: THE PROCTER & GAMBLE COMPANY, PATENT DIVISION, IVORYDALE TECHNICAL CENTER - BOX 474, 5299 SPRING GROVE AVENUE, CINCINNATI, OH, 45217, US

(73) Assignee: The Procter & Gamble Company

(21) Appl. No.: 09/903,255

(22) Filed: Jul. 11, 2001

(30) Foreign Application Priority Data
Jul. 27, 2000 (US) PCT/US00/20499

(51) Int. Cl. C11D 3/50; C11D 9/44

(52) U.S. Cl. 510/101

(57) ABSTRACT

The invention concerns a process and a device for the deodorizing, and/or fragrancing of an environment. In the invention, a device is placed in that environment, which is a container (1) comprising perfumed particles (2) which emit their perfume outside the container.

### SUMMARY OF THE INVENTION

In one embodiment, the invention is a process of deodorizing and/or fragrancing an environment which is sometimes wet and sometimes dry, such as a bathroom, a shower stall, an automatic laundry or dish washing machine, a jacuzzi or a hot tub, where a deodorising and/or fragrancing device is placed inside said environment, said device being a container (1) comprising a plurality of perfumed particles (2) emitting their perfume to the outside of the container, in said environment.

The invention also encompasses such device provided with usage instructions to use it in such a specific environment. The invention also encompasses perfumed particles provided with usage instructions to use them in such a device in such an environment.

In another embodiment, the invention encompasses such a device wherein said container (1) is rigid. In another embodiment, the container (1) comprises holes (3) of different sizes and which are all smaller than the smaller particle (2) contained in said container (1). In another embodiment, the perfumed particles (2) in the container (1) are not all of the same size. In another embodiment, the container (1) contains different particles (2) comprising different perfumes. In yet another embodiment, the container (1) comprises perfumed particles (2) which fill between 5 % and 95 % of the inner volume of said container, preferably 20 % to 80 %.

### DESCRIPTION OF THE FIGURES

FIG. 1 is an outside perspective view of a closed container according to the present invention.

FIG. 2 is an outside perspective view of the container of FIG. 1, in its opened configuration.

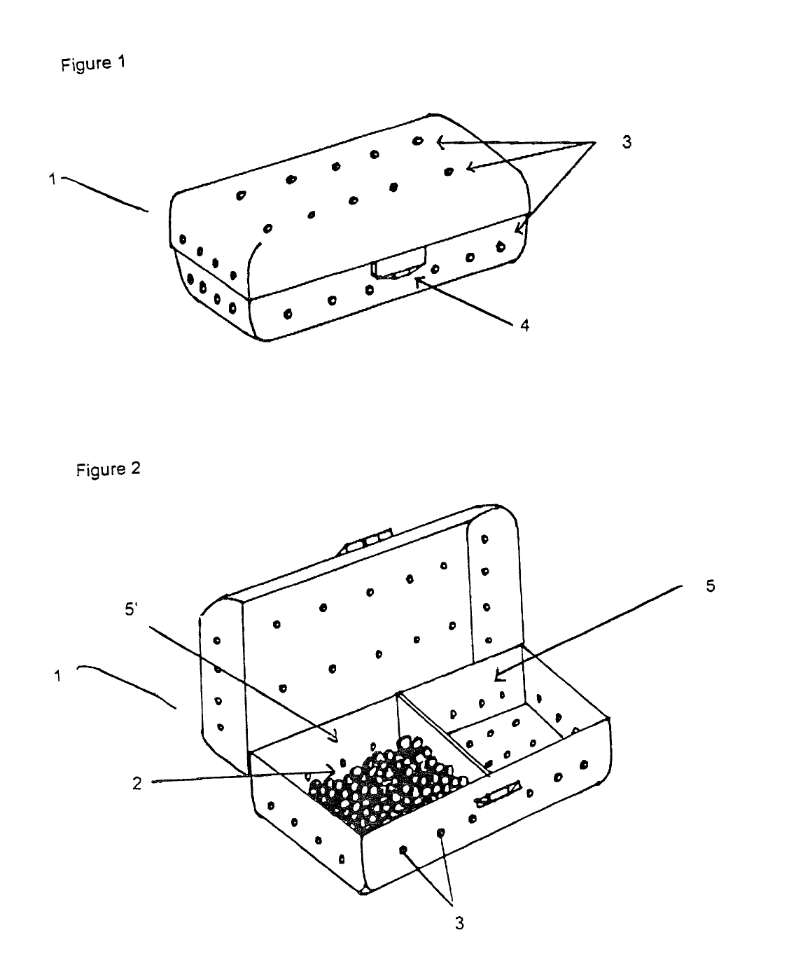

A container (1) is made of polyethylene, and has a length of 9 cm, a width of 5 cm, and a height of 2.5 cm. Holes (3) with a diameter of 0.15 cm are drilled in the container. The container is openable and comprises to that effect a closure (4). The inside of the container is divided in two compartments (5,5′) of equal divisions. Each compartment comprises a population of perfumed particles (2) (not shown in 5).

### DETAILED DESCRIPTION OF THE INVENTION

The device according to the invention is a deodorising and/or fragrancing device. By “deodorising and/or fragrancing”, it is meant that the device emits a perfume which either fragrances an environment, or deodorises it by masking malodors. The device comprises a container which contains perfumed particles emitting their perfume to the outside of the container.

The Container

The device according to and used in the present invention comprises a container. The container can be a flexible sachet, but it is preferably a substantially rigid container, made of plastic, such as polyethylene or polypropylene. Indeed, by using a substantially rigid container, it is ensured that the perfumed particles can move freely inside the container, e.g., because of the vibrations of the washing machine, or because of the water flow in a washing machine or in a shower, maximising the surface area of the particles which is available to release the perfume, thereby improving the duration and the linearity of the release of the perfume. Also, using plastic ensures that the container is useable in wet conditions, whereas traditional deodorising devices use cardboard or paper. Also, the use of plastic ensures that the device is not deteriorated when exposed to a wide range of temperatures which can be encountered in many environments where the device can be used, such as washing machines. A device using paper or cardboard would not resist such an exposure to warm temperatures.

The container must be so as to ensure that the perfume emitted by the particles can diffuse outside. The container can therefore be made of a material which is, as such, permeable to perfumes, for instance LDPE. However, in that embodiment perfume migration through the material may be slow and more difficult to control, so that in a preferred embodiment the container is made of any plastic, and the container comprises holes which are all smaller than the smaller perfume particle contained. In an advantageous embodiment, the holes of the container are not all of the same size. Indeed, holes of different sizes may have different functions: smaller holes may have a predominant role in the release of perfume, while larger holes may be required for a quick enough drying of the device after it had been wet when used in a wet environment. Allowing the inside of the device to dry faster is desirable so as to maintain the efficiency of the device in releasing its perfume.

The container is closed in that it does not allow for particles to be released, but in a particularly advantageous execution, the container is openable and recloseable so that used particles can be disposed of and replaced by fresh particles.

The Perfumed Particles

The particles to be put inside the container are perfumed particles which emit their perfume gradually over time. Particles suitable for use herein may be made of polymers, or clay, or porous rocks or stones such as pumice, silica or silicates.

However, particularly preferred for use herein are polymeric particles such as those which have been disclosed in WO9947182, GB1,589,201, U.S. Pat. Nos. 3,505,432, 4,247,498, 4,156,067, and Scharfft, Modern Plastics Encyclopedia, Mc Graw-Hill Publishing Company, 1982-1983, pp 274-275, all of which are incorporated herein by reference, U.S. Pat. Nos. 4,521,541, 4,542,162, 5,543,398, all incorporated herein by reference.

Simply stated, the process for making such particles involves mixing a molten plastic with the perfume, and allowing the mix to solidify in the appropriate shape.

Any perfume is suitable for use herein, and suitable perfumes for use herein have been disclosed in numerous references, for example in WO9947182 and U.S. Pat. No. 5,540,853, incorporated herein by reference.

The fragrance material within the polymer preferably has a calculated logP in the range of from about 3 up to about 8, wherein P is the partition coefficient of the active or bioactive material between n-octanol and water.

The perfume ingredients are preferred to have a boiling point of 250° C. The logP of many perfume ingredients has been reported; for example, the Pomona92 database, available from Daylight Chemical Information Systems, Inc. (Daylight CIS), Irvine, California contains many, along with citations to the original literature. However, the logP values are most conveniently calculated by the “CLOGP” program, also available from Daylight CIS. This program also lists experimental logP values when they are available in the Pomona92 database. The “calculated logP11 (ClogP) is determined by the fragment approach of Hansch and Leo (cf., A. Leo, in Comprehensive Medicinal Chemistry, Volume 4, C. Hansch, P. G. Sammens, J. B. Taylor and C. A. Ramsden, editors, page 295, Pergamon Press, 1990, incorporated by reference herein). The fragment approach is based on the chemical structure of each perfume ingredient and takes into account the numbers and types of atoms, the atom connectivity and is the chemical bonding. The ClogP values, which are the most reliable and widely used estimates for this physiochemical property, are preferably used instead of the experimental logP values in the selection of perfume ingredients which are useful in the present invention.

Non-enduring perfume ingredients, which are preferably minimized in the present invention, are those having a B.P. of less than about 250° C. or having a ClogP of less than about 3.0 or having both a B.P. of less than about 250° C. and a ClogP of less than about 3.0. The table below gives some non-limiting examples of non-enduring perfume ingredients. The perfume compositions used in the present invention contain less than about 30 weight percent of non-enduring perfume ingredients, preferably less than about 25 weight percent of non-enduring perfume ingredients, more preferably, less than about 20 weight percent of non-enduring perfume ingredients, and even more preferably, less than about 15 weight percent of non-enduring perfume ingredients.

Examples of perfume materials which have a calculated ClogP >3 are as set forth in the following table:

Examples of Enduring Perfume Ingredients Approximate Perfume Ingredients 1 B.P. (—C) (a) ClogP B.P. >250° C. and ClogP >3.0 Allyl cyclohexane propionate 267 3.935 Ambrettolide 300 6.261 Amyl benzoate 262 3.417 Amyl cinnamate 310 3.771 Amyl cinnamic aldehyde 285 4.324 Amyl cinnamic aldehyde dimethyl 300 4.033 acetal iso-Amyl salicylate 277 4.601 Aurantiol 450 4.216 Benzophenone 306 3.120 Benzyl salicylate 300 4.383 para-tert-Butyl cyclohexyl acetate +250 4.019 iso-Butyl quinoline 252 4.193 O-Caryophyllene 2S6 6.333 Cadinene 275 7.346 Cedrol 291 4.530 Cedryl acetate 303 5.436 Cedryl formate +250 5.070 Cinnamyl cinnamate 370 5.48b, Cyclohexyl salicylate 304 5.265 Cyclamen aldehyde 270 3.680 Dihydro isojasmonate +300 3.009 Diphenyl methane 262 4.059 IDiphenyl oxide 252 4.240 Dodecalactone 258 4.359 ISO E SUPER +250 3.45S Ethylene brassylate 332 4.554 Ethyl methyl phenyl glucidate 260 3.165 Ethyl undecylenate 264 4.888 Exaltolide 280 5.346 GALAXOLIDE +250 5.482 IGeranyl anthranilate 1312 14.216.

Examples of Enduring Perfume Ingredients Approximate Perfume Ingredients B.P. (OC) ClogP B.P. >250° C. and ClogP >3.0 +250 5.233 Hexadecanolide 294 6.805 Hexenyl salicylate 271 4.716 Hexyl cinnamic aldehyde 305 5.473 Hexyl salicylate 290 5.260 a-lrone 250 3.820 Lilial (p-tbucinal) 258 3.858 Linalyl benzoate 263 5.233 2-Methoxy naphthalene 274 3.235 Methyl dihydrojasmone +300 4.843 y-n-Methyl ionone 252 4.309 Musk indanone +250 5.458 Musk ketone MP=137° C. 3.014 Musk tibetine MP=136° C. 3.831 Myristicin 276 3.200 oxahexadecanolide-10 +300 4.336.

Oxahexadecanolide-ii MP=350° C. 4.336 Patchouli alcohol 285 4.530 Phantolide 288 5.997 Phenyl ethyl benzoate 300 4.058 Phenyl ethyl phenyl acetate 325 3.767 Phenyl heptanol 261 3.478 Phenyl hexanol 258 3.299 cc-santalol 301 3.800 Thibetolide 280 6.246 8-Undecalactone 290 3.830 table-continued Examples of Enduring Perfume Ingredients Approximate Perfume Ingredients 1 B.P. (OC) (a) ClogP B.P. >250° C. and ClogP >3.0 y-Undecalactone 297 4.140 Vetiveryl acetate 285 4.882 Yara-yara 274 30235 Ylangene 250 6.268 (a) M.P. is melting point; these ingredients have a B.P. higher than 250° C.

In the preferred embodiment herein where the particles are made of plastic, it is ensured that water, whenever present, does not permeate the particles so that the perfume components present within the particles are protected until they are released. Furthermore, the use of plastic ensures that the particles are not deteriorated when the device is exposed to warm temperatures. The device is thus useable across a wide range of temperatures.

The particles herein are preferably substantially spherical, as opposed to rods or square or rectangular blocks. Indeed, when spherical, the particles have increased mobility inside the device, so that fresh and clean surfaces of the particles are exposed over time. A contrario, with restricted mobility, the same surfaces of the particles would be exposed over time, and they would become soiled and potentially clogged. Furthermore, a spherical shape—combined with the fact that the particles are preferably made of plastic, therefore hydrophobic—ensures that water droplets, when present, run off the surface of the particles, contributing to a faster drying of the particles, hence a more efficient release of the perfume after exposure to wet conditions.

Perfume loading of the particles can vary within broad ranges, depending on the particular demands for a particular device. Indeed, in a compact device, the total amount of particles may tend to be on the low side and thus the perfume loading for each particle will tend to increase, so as to compensate for the fewer particles present. Conversely, in a large device, there may be more particles and the particles will tend to carry a lighter perfume load. Particles herein typically carry between 2 %-25 % by weight of perfume, and the total weight of the particles may represent from 20 grams to 75 grams.

Suitable perfumed particles for use herein are commercially available from International Flavors and Fragrances (IFF) under the trade-name Polyiff.

The population of particles in a given container can be substantially homogeneous in terms of their perfume content, but it can be attractive to have a heterogeneous population. Indeed, certain particles comprising certain perfumes can be manufactured as homogeneous populations, in batches, and then the different populations can be mixed together in an infinity of variations, offering an economically attractive flexibility in the choice of perfumes and functionality. Indeed, perfumes can be used which will additionally provide sanitisation and/or antibacterial benefits.

The population of particles in a given container can be substantially homogeneous in size, and that is desirable as compared to a heterogeneous population. Indeed, a homogeneous population in size ensures, for spherical particles, that there is a minimum contact surface between the particles, and surface damage and/or abrasion is reduced. Also, the risk of particles compaction is substantially reduced which would reduce the rate of perfume release, and which would impede free rotation of the particles, which in turn would impede a prolonged and gradual release of the perfume. The container may also be divided in several compartments which will each comprise a particular population of particles. The population of particles in a given compartment will preferably differ from the population in another compartment.

Preferably, the particles inside the container should fill between 5 % and 95 % of the inner volume of the container or each compartment, most preferably 20 % to 80 %. Indeed, inside those limits a best compromise is obtained between the amount of particles, which desirably should be as large as possible to increase the perfume loading of the device, and their ability to move in the container, so as to improve the duration and linearity of the release of the perfume, which at a certain point becomes hindered if too many particles are present.

The process

In the process according to the present invention, a device as described herein above is placed in an environment which is sometimes wet and sometimes dry, such as a bathroom, a shower stall, an automatic laundry or dish washing machine, a jacuzzi or a hot tub, so as to deodorise and/or perfume that environment. Indeed, a particular advantage of the devices to be used herein is that they are effective in both wet and dry conditions, and across a wide range of temperatures, as described earlier.

Products with Usage Instructions

In another embodiment of the present invention, the device described herein above is provided together with usage instructions to use it in a process described hereinabove, so as to make the best possible use of the device's unique advantages. In that embodiment, a product is provided which comprises a deodorising and/or fragrancing device which is a container comprising a plurality of perfumed particles emitting their perfume to the outside of the container, and usage instructions to place said device inside an environment which is sometimes wet and sometimes dry, such as a bathroom, a shower stall, an automatic laundry or dish washing machine, a jacuzzi or a hot tub.

In another embodiment of the present invention, perfumed particles are provided separately from the container of the device as described hereinabove, as refills for said device. In that embodiment, a product is provided comprising perfumed particles emitting their perfume, and usage instructions to place said particles into a container which will enable said particles to emit their perfume outside said container, and to place said container inside an environment which is sometimes wet and sometimes dry, such as a bathroom, a shower stall, an automatic laundry or dish washing machine, a jacuzzi or a hot tub. The usage instructions may specify that the device has to be emptied of its used particles before fresh particles are provided.

What is claimed is:

1. A process of deodorizing and/or fragrancing an environment which is sometimes wet and sometimes dry, such as a bathroom, a shower stall, an automatic laundry or dish washing machine, a jacuzzi or a hot tub, wherein a deodorising and/or fragrancing device is placed inside said environment, said device being a container comprising a plurality of perfumed particles emitting their perfume to the outside of the container, in said environment.

2. A product comprising a deodorising and/or fragrancing device which is a container comprising a plurality of perfumed particles emitting their perfume to the outside of the container, and usage instructions to place said device inside an environment which is sometimes wet and sometimes dry, such as a bathroom, a shower stall, an automatic laundry or dish washing machine, a jacuzzi or a hot tub.

3. A product comprising perfumed particles emitting their perfume, and usage instructions to place said particles into a container which will enable said particles to emit their perfume outside said container, and to place said container inside an environment which is sometimes wet and sometimes dry, such as a bathroom, a shower stall, an automatic laundry or dish washing machine, a jacuzzi or a hot tub.

4. A product according to claim 3 wherein said perfumed particles are polymeric particles.

5. A product according to claim 3 wherein said particles are substantially spherical.

6. A product according to claim 3 wherein said container is rigid.

7. A product according to claim 3 wherein said container comprises holes which are all smaller than the smaller particle contained in the container.

8. A product according to claim 3 wherein said container comprises holes of different sizes.

9. A product according to claim 3 wherein said perfumed particles are all of substantially the same size.

10. A product according to claim 3 wherein different perfumed particles comprise different perfumes.

11. A product according to claim 3 wherein said container is openable and recloseable.

12. A product according to claim 3 wherein said container comprises perfumed particles which fill between about 5 % and about 95 % of the inner volume of said container.

13. A device comprising a rigid container comprising perfumed particles emitting their perfume outside said container.

14. A device according to claim 13 wherein said particles are substantially spherical.

15. A device comprising a container which comprises perfumed particles emitting their perfume outside said container, said container comprising holes of different sizes which are all smaller than the smaller particle contained in said container.

16. A device comprising a container which comprises perfumed particles emitting their perfume outside said container, and said particles are all of substantially the same size.

17. A device comprising a container which comprises perfumed particles emitting their perfume outside said container, and different said particles comprise different perfumes.

18. A device comprising a container which comprises perfumed particles emitting their perfume outside said container, wherein said particles fill between about 5 % and about 95 % of the inner volume of said container.
